(19) United States
(12) Patent Application Publication
(10) Pub. No.: US 2025/0117480 A1
(43) Pub. Date: Apr. 10, 2025

(54) CODE ANALYSIS FOR PRIVACY AND RISK ASSESSMENT USING A TRAINED MACHINE-LEARNING MODEL

(71) Applicant: Devron Corporation, New York, NY (US)

(72) Inventors: Sameer WAGH, Jersey City, NJ (US); Kartik CHOPRA, New York, NY (US); Sidhartha ROY, Cambridge, MA (US)

(73) Assignee: Devron Corporation, New York, NY (US)

(21) Appl. No.: 18/484,058

(22) Filed: Oct. 10, 2023

(51) Int. Cl. G06F 21/56; G06F 21/57; G06F 21/62; G06N 3/0455; G06N 3/092

(52) U.S. Cl. CPC G06F 21/563; G06F 21/577; G06F 21/6218; G06N 3/0455; G06N 3/092; G06F 2221/033

(57) ABSTRACT

Systems and methods for code analysis are provided. A system receives, from a first data owner system, an input indicating one or more privacy constraints, wherein the one or more privacy constraints indicate one or more rules for operating on a sensitive data set in a data store associated with the first data owner system. The system receives data comprising code configured to operate on the sensitive data set. The system apples a first set of one or more machine-learning-trained models to process the first input and the data comprising the code to generate code analysis output data, wherein the code analysis output data comprises an indication of whether the code satisfies the one or more privacy constraints. The system generates and transmits, based on the code analysis output data, an instruction indicating whether to execute the code to operate on the sensitive data.

### FIELD

The present disclosure relates generally to code analysis systems, and more specifically to code analysis systems for enforcing privacy and security constraints for remote code execution.

### BACKGROUND

Software applications increasingly process private and sensitive user data. In order to balance the trade-offs between privacy and utility, many applications rely on remote code execution capabilities. Additionally, many software applications seek to leverage data sets drawn from a variety of different sources, where data sets provided by different data sources may carry different privacy requirements.

### SUMMARY

In software applications leveraging remote code execution capabilities and relying on data sets associated with different parties and different data privacy requirements, enforcement of customizable and granular privacy constraints is needed.

Traditional static code analysis techniques, which involve inspecting code without executing it to uncover vulnerabilities, bugs, and code quality issues, face challenges in accurately analyzing complex program logic and modern coding practices. Limitations of traditional static code analysis techniques include, for example, the analysis targeting only known security vulnerabilities, as opposed to accurately identifying privacy violations. As used herein, security and access may refer to whether a party or system is authorized to access a data store or a data set, while privacy constraints may refer to more granular controls governing whether a party or system is authorized to access specific data values in a data set, and what permissions the party or system has with respect to the specific data value, including whether the party or system has permissions to read the raw data, to read an obfuscated version of the data value, to read a redacted version of the data value, to read synthetic data generated based on the data value, to read statistical data generated based on the data value, and/or to read other insight data computed based on the value without exposing the raw underlying data value. Privacy is largely context-dependent and thus is more difficult to detect than security vulnerabilities, as the latter have specific fingerprints that make them easy to detect.

Other limitations of traditional static code analysis techniques include limited effectiveness over dynamic languages such as Python or Ruby, and/or poor performance due to the use of predetermined rules and patterns.

Furthermore, traditional static analysis tools may fail to detect privacy constraints and/or other code issues that are masked by code obfuscation techniques.

Accordingly, there is a need for improved systems and methods for performing automated code analysis for detecting privacy violations, allowing enforcement of customizable and granular privacy constraints including in remote code execution environments. Disclosed herein are systems and methods that may address said identified need.

Disclosed herein are systems and methods for code analysis using one or more trained machine-learning models to provide enforcement of privacy constraints in automated code analysis. In particular, in some embodiments, one or more large language models (LLMs) are leveraged to perform code analysis for privacy enforcement as described herein.

In some embodiments, a system for privacy-preserving code monitoring and analysis is provided, wherein the system leverages one or more trained machine-learning models to accept user inputs regarding privacy customization information, receive code data and associated information, analyze said code data subject to the received privacy customization information, and generate and provide output regarding whether the analyzed code complied with one or more context-dependent privacy criteria. Based on the determination as to whether the code data complies with the one or more privacy criteria, the system may, in some embodiments, cause the code to be automatically executed or automatically blocked from execution, for example in the case of integration with a remote code management system.

The techniques described herein may be used for remote code execution applications, and may be particularly effective for allowing customization of privacy for data usage in various scenarios. Furthermore, the techniques described herein may provide increased user-friendliness and increased usability that allows users to customize privacy rules to enterprise scenarios. The techniques described herein may enable increased flexibility and functionality for federated learning systems in which granular, customizable, and flexible privacy controls are required to integrate data sets drawn from different sources and including data having varying levels of privacy sensitivity.

In some embodiments, a system for code analysis is provided, the system comprising one or more processors configured to: receive, from a first data owner system, a first input comprising an indication of one or more privacy constraints, wherein the one or more privacy constraints indicate one or more rules for operating on a sensitive data set in a data store associated with the first data owner system; receive, from a system authorized to access the data store, data comprising code configured to operate on the sensitive data set; apply a first set of one or more machine-learning-trained models to process the first input comprising the indication of the one or more privacy constraints and the data comprising the code to generate code analysis output data, wherein the code analysis output data comprises an indication of whether the code satisfies the one or more privacy constraints; and generate and transmit, based at least in part on the code analysis output data, an instruction for the system authorized to access the data store, the instruction indicating whether to execute the code to operate on the sensitive data.

In some embodiments, the one or more processors are configured to: before applying the first set of one or more models, determining that the system authorized to access the data store satisfies one or more access permission criteria; wherein applying the first set of one or more models is performed in accordance with determining that the one or more access criteria are satisfied. In some embodiments, the one or more processors are configured to: before applying the first set of one or more models, determining that a user of the system authorized to access the data store satisfies one or more access permission criteria; wherein applying the first set of one or more models is performed in accordance with determining that the one or more access criteria are satisfied. In some embodiments, the system authorized to access the data store is a server in a federated learning system. In some embodiments, the data store is a satellite data store in a federated learning system. In some embodiments, the one or more privacy constraints indicating the one or more rules for operating on the sensitive data set indicate whether a raw data value can be permissibly read by the code and whether data generated based on the raw data value can be permissibly ready by the code. In some embodiments, the data generated based on the raw data value comprises one or more data types selected from: obfuscated data, redacted data, statistical data, and synthetic data. In some embodiments, the one or more privacy constraints indicating the one or more rules for operating on the sensitive data set indicate differential privacy rules for data operations on the same data by different parties. In some embodiments, the system authorized to access the data store is a remote code execution engine. In some embodiments, the one or more machine-learning-trained models comprise a plurality of models configured in a mixture-of-experts configuration. In some embodiments, the one or more trained models comprise a large language model (LLM). In some embodiments, the code analysis output data comprises an explainability indicator providing a human-readable explanation of one or more reasons that the code does or does not satisfy the one or more privacy constraints. In some embodiments, the one or more processors are configured to: based at least in part on the code analysis output data, transmit information to the first data owner system soliciting input from the data owner system regarding whether the code satisfies the one or more privacy constraints; and receive, from the data owner system, responsive to the information soliciting input, a second input comprising an indication of whether the code satisfies the one or more privacy constraints; wherein generating and transmitting the instruction indicating whether to execute the code to operate on the sensitive data is based at least in part on the second input comprising the indication of whether the code satisfies the one or more privacy constraints. In some embodiments, the one or more processors are configured to update at least one of the first set of one or more machine-learning-trained models by further training the at least one model based at least in part on the code and based at least in part on the second input comprising the indication of whether the code satisfies the one or more privacy constraints. In some embodiments: the instruction indicating whether to execute the code indicates to execute the code; and the one or more processors are configured to, in accordance with the instruction, cause the system authorized to access the data store to execute the code.

In some embodiments, a non-transitory computer-readable storage medium storing instructions for code analysis is provided, the instructions configured to be executed by one or more processors of a system to cause the system to: receive, from a first data owner system, a first input comprising an indication of one or more privacy constraints, wherein the one or more privacy constraints indicate one or more rules for operating on a sensitive data set in a data store associated with the first data owner system; receive, from a system authorized to access the data store, data comprising code configured to operate on the sensitive data set; apply a first set of one or more machine-learning-trained models to process the first input comprising the indication of the one or more privacy constraints and the data comprising the code to generate code analysis output data, wherein the code analysis output data comprises an indication of whether the code satisfies the one or more privacy constraints; and generate and transmit, based at least in part on the code analysis output data, an instruction for the system authorized to access the data store, the instruction indicating whether to execute the code to operate on the sensitive data.

In some embodiments, the instructions are configured to be executed by one or more processors of a system to cause the system to: based at least in part on the code analysis output data, transmit information to the first data owner system soliciting input from the data owner system regarding whether the code satisfies the one or more privacy constraints; and receive, from the data owner system, responsive to the information soliciting input, a second input comprising an indication of whether the code satisfies the one or more privacy constraints; wherein generating and transmitting the instruction indicating whether to execute the code to operate on the sensitive data is based at least in part on the second input comprising the indication of whether the code satisfies the one or more privacy constraints. In some embodiments, the instructions are configured to be executed by one or more processors of a system to cause the system to update at least one of the first set of one or more machine-learning-trained models by further training the at least one model based at least in part on the code and based at least in part on the second input comprising the indication of whether the code satisfies the one or more privacy constraints.

In some embodiments, a method for code analysis is provided, the method configured to be performed by a system comprising one or more processors, the method comprising: receiving, from a first data owner system, a first input comprising an indication of one or more privacy constraints, wherein the one or more privacy constraints indicate one or more rules for operating on a sensitive data set in a data store associated with the first data owner system; receiving, from a system authorized to access the data store, data comprising code configured to operate on the sensitive data set; applying a first set of one or more machine-learning-trained models to process the first input comprising the indication of the one or more privacy constraints and the data comprising the code to generate code analysis output data, wherein the code analysis output data comprises an indication of whether the code satisfies the one or more privacy constraints; and generating and transmitting, based at least in part on the code analysis output data, an instruction for the system authorized to access the data store, the instruction indicating whether to execute the code to operate on the sensitive data.

In some embodiments, the method comprises: based at least in part on the code analysis output data, transmitting information to the first data owner system soliciting input from the data owner system regarding whether the code satisfies the one or more privacy constraints; and receiving, from the data owner system, responsive to the information soliciting input, a second input comprising an indication of whether the code satisfies the one or more privacy constraints; wherein generating and transmitting the instruction indicating whether to execute the code to operate on the sensitive data is based at least in part on the second input comprising the indication of whether the code satisfies the one or more privacy constraints. In some embodiments, the method comprises updating at least one of the first set of one or more machine-learning-trained models by further training the at least one model based at least in part on the code and based at least in part on the second input comprising the indication of whether the code satisfies the one or more privacy constraints.

Any one or more of the embodiments described above may be combined, in whole or in part, with one another and/or with all or part of any other embodiment or disclosure herein.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE FIGURES

Various aspects of the disclosed methods and systems are set forth with particularity in the appended claims. A better understanding of the features and advantages of the disclosed methods and systems will be obtained by reference to the following detailed description of illustrative embodiments and the accompanying drawings, of which:

FIG. 1 depicts a system for code analysis, in accordance with some embodiments;

FIG. 2 depicts a method for code analysis, in accordance with some embodiments; and

FIG. 3 depicts a computing device, in accordance with some embodiments.

FIG. 4 depicts code analyzed by a system for code analysis, in accordance with some embodiments;

FIG. 5 depicts code analyzed by a system for code analysis, in accordance with some embodiments; and

FIGS. 6A-6B depict code analyzed by a system for code analysis, in accordance with some embodiments.

### DETAILED DESCRIPTION

Described herein are methods and systems for privacy-preserving code monitoring and analysis, wherein a system leverages one or more trained machine-learning models (e.g., one or more LLMs) to accept user inputs regarding privacy customization information, receive code data and associated information, analyze said code data subject to the received privacy customization information, and generate and provide output regarding whether the analyzed code complied with one or more context-dependent privacy criteria. Based on the determination as to whether the code data complies with the one or more privacy criteria, the system may cause the code to be automatically executed or automatically blocked from execution, for example in the case of integration with a remote code management system.

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are accorded the scope consistent with the claims.

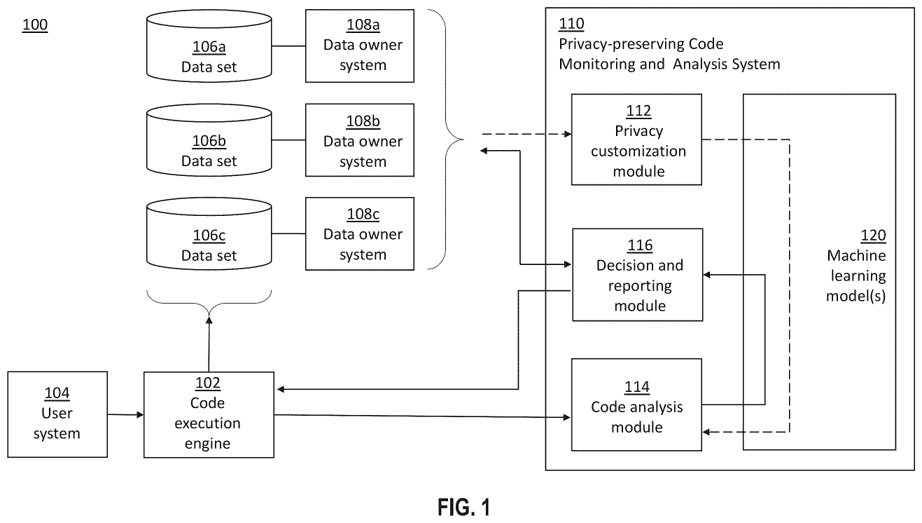

FIG. 1 illustrates a system 100 for code analysis, in accordance with some embodiments. System 100 may include one or more processor-based devices such as servers, computer systems, and/or computer devices, which may be communicatively coupled and arranged with respect to one another and/or with respect to one or more computer storage devices as shown in FIG. 1 and as described herein.

System 100 may be configured to perform techniques for remote code analysis assessing and ensuring privacy of user data. As described herein, system 100 may perform code execution (e.g., remote code execution) on one or more of a plurality of data sets. Because the data sets may include sensitive data for which privacy preservation is important, execution of code against the data sets may be subject to confirmation that one or more privacy constraints will not be violated by execution of the code. To ensure that privacy constraints are not violated, system 100 may leverage an ML-powered (e.g., LLM-powered) privacy-preserving code monitoring and analysis system (“code analysis system”). As described in greater detail herein, the code analysis system may be configured to accept inputs including privacy customization inputs, prompt inputs, and code itself; the code analysis system may then use one or more ML-trained models (e.g., LLMs) to process the code subject to the inputs in order to generate output data comprising an indication of whether the code violates one or more privacy constraints and including explainability data (e.g., a human-readable explanation) as to whether, in what manner, and/or to what extent the code violates the one or more privacy constraints. Based on the output data generated by the code analysis system, system 100 may generate an output to be transmitted to and/or displayed for a user attempting to execute the code, may automatically approve or reject execution of the code, and/or may transmit a request for additional input and/or human intervention to determine whether the code should be executed.

As shown in FIG. 1, system 100 may include code execution engine 102, which may include one or more processors configured to execute code. Code execution 102 may be provided on a local computing device and/or by one or more servers in network environment and/or a distributed computing environment.

In some embodiment, code execution engine 102 may be part of a remote code execution system that allows various users to send code to the system for execution by engine 102. In some embodiments code execution engine 102 may be communicatively coupled to user system 104. For example, user system 104 may transmit code (and, optionally, additional associated data) to code execution engine 104, optionally along with instructions for one or more data sets against which the code is to be executed.

Code execution engine 102 ma be communicatively coupled with one or more data sets 106a-106c. Data sets 106a-106c may be each be stored on any suitable computer-readable storage medium, and may be provided in any suitable database or other data storage format. Data sets 106a-106c may be stored on the same storage medium as one another, or may be stored on separate storage mediums (as shown in FIG. 1). The code provided to code execution engine 102 and executed by code execution engine 102 may operate on one or more of data sets 106a-106c. Operating on data sets 106a-106c may include reading from a data set, writing to a data set, and/or performing one or more mathematical operations on a data set. Operating on data sets 106a-106c may in some embodiments include computing, requesting, and/or reading insight data from a data set without reading raw values from a data set, where insight data may include mathematical information such as median values or mean values, redacted information, obfuscated information, and/or synthetic data values computed based on the underlying raw data values.

In some embodiments, one or more of data sets 106a-106c may be associated with a respective data owner system 108a-108c. A data owner system may be any computer system that has permissions for controlling access to and privacy of a corresponding data set. In some embodiments, the same data owner system may have permissions for controlling access to and privacy of one or more data sets. In some embodiments, data sets 106a-106c and data owner systems 108a-108c may be provided as part of a federated learning environment, wherein each data set and its respective data owner system are provided as a “satellite system” in a federated learning arrangement. In such a federated learning environment, data sets at a satellite system ay be fully visible to the respective data owner system, but may have different levels of visibility (e.g., different access permissions and/or different privacy constraints) for a central system in the federated learning system and/or for other satellite systems in the federated learning system.

Data owners may use data owner systems 108a-108c to execute inputs that define (e.g., create and/or modify) access control rules and/or privacy constraints for determining what users may access their data, when their data may be accessed, the manner in which their data may be accessed, and how their data may (or may not) be operated on. Access controls and/or privacy constraints may be granular in that they may vary for different parts of a data set (e.g., some data in a data set may be considered more sensitive than other data in the same data set) and/or may vary for access by different systems or different parties (e.g., some systems/parties may have greater access permissions and/or greater privacy permissions that other systems/parties). As described in greater detail below, data owner systems 108a-108c may in some embodiments defined access controls and/or privacy constraints by providing one or more inputs to privacy-preserving code monitoring and analysis system 110 (hereinafter “code analysis system 110”).

As shown in FIG. 1, system 100 may comprise code analysis system 110, which may comprise one or more processors and may be communicatively coupled to code execution engine and/or to data owner systems 108a-108c. Code analysis system 110 may comprise one or more processors and may be configured to accept inputs comprising code, privacy constraints, and/or prompts. Code analysis system 110 may be configured to perform one or more data processing operations based on the inputs received, for example by processing the code received to determine whether the code is or is not compliant with one or more privacy constraints, for example as defined by or determined based on the received privacy constraints input and/or the received prompt input. The data processing operation(s) executed by code analysis system 110 may generate output data comprising an indication of whether the received code complies with one or more privacy constraints. The output data may also optionally include explainability data explaining how and/or to what extent privacy constraints are or are not satisfied. The output data may also optionally include an instruction to automatically execute or to automatically not execute the code, in accordance with whether it has been determined that the privacy constraints are satisfied. The output data may also optionally include a transmission to one or more of data owners 108a-108c that may include a request for further input, such as a request for additional information needed to determine whether privacy constraints are satisfied and/or a request for an input indicating whether to execute code (for example in the instance of an “edge case” where human input should be used to determine whether to execute code).

In some embodiments, code analysis system 110 may be used to analyze and/or determine whether to execute code in any suitable computer environment and/or in any suitable network environment. In some embodiments, code analysis system 110 may be used to augment a remote code execution system such as code execution engine 102 in order to enhance privacy preservation for remote code execution systems. In some embodiments, code analysis system 110 may be used in a federated learning system in which multiple different data sets controlled by different data owners have different privacy constraints. In this way, code analysis system 110 may provide improved data privacy capabilities for remote code execution systems and/or for federated learning systems.

As shown in FIG. 1, code analysis system 110 may include privacy customization module 112, code analysis module 114, decision and reporting module 116, and machine learning model(s) 120. Each of the modules 112, 114, and 116 may comprise one or more dedicated processors and/or one or more shared processors with one or more of the other modules 112, 114, and 116. Each of the modules 112, 114, or 116 may comprise one or more computer-readable storage media and/or one or more shared computer-readable storage media with one or more of the other modules 112, 114, or 116. Each of the modules may be configured to provide certain functionalities of code analysis system 110, including by receiving input data (e.g., inputs from data owner systems 108 and/or from code execution engine 102), by performing data processing operations on the input data received, and/or by providing/transmitting output data (e.g., output data transmitted to data owner systems 108 and/or to code execution engine 102).

Each of the modules 112, 114, and 116 may be configured to leverage machine learning model(s) 120, which may provide a data processing backbone for code analysis system 110. In some embodiments, machine learning model(s) 120 may include a single machine-learning model; in some embodiments, machine learning model(s) 120 may include a plurality of machine-learning models arranged in any suitable manner, such as in a mixture of experts and/or ensemble paradigm. In some embodiments, when machine learning model(s) 120 comprise a plurality of machine learning models, different models may be configured to provide different functionalities to one or more of the modules 112, 114, and 116. In some embodiments, a plurality of models may work cooperatively (e.g., in parallel and/or in series) with one another to process data to provide one or more functionalities to one or more of the modules 112, 114, and 116.

In some embodiments, machine learning model(s) may comprise one or more large language models (LLMs). A LLM deployed as all or part of machine learning model(s) 120 may be configured to accept human-readable and/or machine-readable text-based input, code input, tabular input, graphical input, and/or input in any one or more other suitable data formats or file formats. The LLM may be configured to process the received data and to generate output data (including privacy constraint compliance determination data, explainability data, and/or data requesting further information and/or human input) in any suitable format. The format of output data generated by the LLM may include human-readable and/or machine-readable text, tabular output, graphical output, and/or output in any one or more other suitable data formats or file formats.

As shown by the arrows in FIG. 1, privacy customization module 112 may be configured to accept input from data owner systems 108a-108c. This input may comprise instructions regarding customization for privacy criteria for a specific data owner system, a specific data set, and/or specific data (e.g., one or more specific data fields and/or data values) within a specific data set. A privacy customization input may define what permissions are available for a specific user, specific kinds of users (e.g., roles), and/or for all users. Privacy customization inputs may define whether one or more users have permissions to read a raw data, to read an obfuscated version of a data value, to read a redacted version of a data value, to read synthetic data generated based on a data value, to read statistical data generated based on a data value, and/or to read other insight data computed based on a value without exposing the raw underlying data value. A privacy customization input may further provide information about a specific system that defines the privacy context of the system.

In one example of a privacy customization input providing information about a specific system to define privacy context of the system, consider a use case in which a cloud storage system is used. Suppose that data belonging to a single data owner is stored in two buckets: bucket A and bucket B. Privacy customization inputs may allow the data owner to instruct the system, via a privacy customization input, to consider all data in bucket A as private or sensitive and to consider all data in bucket B as public (e.g., non-private or non-sensitive). In this case, the privacy customization input may thus define a privacy context in which different privacy constraints are applied to different data that is controlled by a single data owner. Another example of a privacy constraint applied by a privacy customization input is a privacy customization input specifying that all (or certain) JSON files are private (sensitive) for data controlled by a data owner. Yet another example of a privacy constraint applied by a privacy customization input is a privacy customization input specifying that user having a predefined privilege/permission may view, operate on, and/or otherwise access certain files controlled by a data owner. Yet another example of a privacy constraint applied by a privacy customization input is a privacy customization input specifying which data columns (e.g., those relating to personal identifying information) must be redacted before being viewed by what kinds of users (e.g., before being viewed by data scientists).

In some embodiments, privacy customization inputs may enable the system to take into account rules and regulations of an organization, for example by accounting for rules that designate which files for an organization should be considered sensitive, what data can be viewed and/or operated on with and without redaction and/or obfuscation, what user have which permissions to view and/or operate on data, etc.

Privacy customization inputs may be provided, e.g., via a graphical user interface, in the form of natural-language human-readable text, and may be processed via code analysis system 110 using machine learning model(s) 120. In one example of a privacy customization input provided in human-readable text format, a user of a data owner system may specify “No data should leave this S3 bucket.” In another example of a privacy customization input, the system may be provided complex legal documents and/or complex organizational policy documents, which can be parsed using the machine learning model(s) 120.

In some embodiments, privacy customization inputs are collected by code analysis system 110 during an initialization phase (as indicated in FIG. 1 by the dotted line arrows), such that privacy customizations may be performed once per data owner system, once per data set, and/or once per data item within a data set. After initialization during which privacy customization inputs have been collected, information regarding the privacy customization inputs may be stored so that the information can be applied to one or more future determinations made with respect to code being analyzed and or with respect to prompts being answered by system 110. In some embodiments, updated privacy customization inputs may be collected intermittently, at predefined intervals, responsive to user request/input, and/or for each time code is analyzed with respect to code that seeks to operate on data to which the privacy customization pertains.

In some embodiments in addition to and/or as a part of privacy customization inputs received by privacy and customization module 112 of code analysis system 110, privacy and customization module 112 may receive input data comprising a prompt that may be used to directly prompt machine learning model(s) 120 to respond in a certain manner during code analysis. A prompt may include, for example, specific instructions for how to analyze code, issues to determine when analyzing code, issues to flag or not flag when analyzing code, and/or specific reasons to execute or not execute code in response to code analysis. In some embodiments, prompts may provide more specific instructions/queries that may be used in conjunction with (and in some embodiments may override) other privacy customization inputs. In some embodiments, privacy customization inputs may generally be applicable to a data owner system, data store, data set(s), data type(s), and or specific data value(s) persistently across analyses performed for multiple different code samples, while a prompt may be specific to a single code sample (or a single set of code samples) to be analyzed. In other embodiments, prompts may apply persistently to code samples to be analyzed for a specific data owner system, data store, data set(s), data type(s), and or specific data value(s), until or unless specified otherwise.

In some embodiments, system 100 may be configured such that code analysis can be performed by code analysis system 110 whether or not a specific prompt is provided. For example, code analysis system 110 may be configured such that, in the absence of a specific prompt being provided, a default set of privacy criteria are applied, in consideration of any other privacy customization information provided regarding the data set to be operated on by the code being analyzed.

As shown by the arrows in FIG. 1, code analysis module 114 may be configured to accept information from machine learning model(s) 120 and to accept input from code execution engine 102. In some embodiments, code for potential execution may be transmitted from code execution engine 102, optionally along with metadata regarding the code, to code analysis module 114. Code analysis module 114 may then process the received code, along with the received privacy customization information, via machine learning model(s) 120. In some embodiments, processing the analyzed code via machine learning model(s) 120 may comprise performing the task of program synthesis. In some embodiments, machine learning model(s) 120 may comprise a customized LLM guided by the self-instruct paradigm and few-shot learning. In some embodiments, machine learning model(s) 120 may additionally or alternatively comprise one or more pre-trained LLMs such as GPT, CLAUDE, BARD, etc. In some embodiments a mixture-of-experts paradigm may leverage multiple models, e.g., multiple LLMs, which may offer improved performance over using a single model. Fine-tuning of any foundational model can be used to enhance performance. In some embodiments, for example in those applications in which throughput may be less important than accurate categorization of a code snippet, quantized and C++ variants of models and/or techniques such as low rank approximation (LoRA) can be used in addition to or in place of one or more LLMs, providing a cost efficient and computationally-efficient option.

Processing the received code via the trained and configured machine learning model(s) 120 may incorporate the power of machine learning and, in some embodiments, LLMs to (1) understand code logic and flow and to (2) understand the privacy customization and instruction to provide an accurate response on the privacy posture of a given code snippet.

In some embodiments, retriever-aware prompts can also be used to further improve the performance using a small known corpus of code snippets.

In some embodiments, an LLM used as part of model(s) 120 may be specifically configured and/or used in a manner that improves performance using one or more techniques.

A first technique for improving performance of the LLM may comprise prompt engineering. Prompt engineering may include one or more techniques such as few-shot learning, chain-of-thought prompting, and/or ReAct prompting that can quickly improve model performance on specific tasks. These techniques may help decompose the problem into smaller parts and may considerably improve performance in logical reasoning domains. In some embodiments, prompt engineering may comprise providing one or more question-answer examples within the prompt as a guide to the LLM. In some embodiments, prompt engineering may enable more synergistic transfer between reasoning traces and task-specific actions to provide quality outcomes. Prompt engineering thus may improve performance by of the systems disclosed herein by improving the depth to which the LLM understands the code logic.

A second technique for improving performance of the LLM may comprise retrieval augmented generation. Retrieval augmented generation may comprise the use of a specialized corpus of data (which may or may not be from the data used for training of the LLM) to assist in responding to a prompt. The LLM may utilize a input such as code and/or a specific prompt, as well as utilizing one or more relevant portions of the corpus, to respond to a query. In some embodiments, the LLM may use similarity scores on a vector database that encodes the information from the corpus of data. In systems such as those disclosed herein, a corpus of quality labelled data of code samples, as well as samples from live usage of the system, may be provided to an LLM and used for retrieval augmented generation.

A third technique for improving performance of the LLM may comprise fine-tuning. Fine-tuning may comprise using a pre-trained model (e.g., LLM) and training some or all of the internal parameters (weights). This approach may include using one or more quality labelled datasets for training of the parameters. To achieve improved performance using fine-tuning, techniques such as the use of experts (e.g., human annotators), language model self improvement (LMSI) which may generate such datasets using the same model, and/or reinforcement learning with human feedback (RLHF).

Code analysis module 114 may generate as output, via the one or more machine learning model(s) 120, output data comprising one or more of: (a) an indication of whether privacy constraints (e.g., as specified by the privacy customization data and/or as specified by one or more prompts received by code analysis system 110) are satisfied; (b) explainability data indicating a reason, a manner, and/or an extent to which privacy constraints are or are not satisfied, and/or indicating one or more modifications to the code that may be made to cause the code to be compliant with privacy constraints in cases in which the code is not compliant with privacy constraints; (c) an instruction to execute code or to not execute code in accordance with a determination as to whether privacy constraints are satisfied; (d) a request for additional information needed to programmatically determine whether privacy constraints are satisfied; and (e) a request for an outside input indicating a decision as to whether the code should be executed, for example in an “edge case” scenario in which system 110 does not make a decision and solicits a decision by an outside system and/or by a human administrator.

In some embodiments, the indication of whether privacy constraints are satisfied may include, may be used to generate, and/or may be provided in the form of a risk assessment. For example, the output may include an indication of a risk level, a risk categorization, and/or a risk score. In this way, the systems and methods disclosed herein may provide risk assessment techniques.

As shown by the arrows in FIG. 1, decision and reporting module 116 may be configured to accept information from code analysis module (e.g., by accepting output data generated by machine learning model(s) 120) and to responsively facilitate transmission of information based on the generated output to and/or from privacy customization module 112 and/or code analysis module 114.

In some embodiments, decision and reporting module 116 may, in accordance with a determination made by system 110 that the analyzed code complies with privacy constraints, transmit instructions to code execution engine 102 to execute the analyzed code. In some embodiments, decision and reporting module 116 may, in accordance with a determination made by system 110 that the analyzed code does not comply with privacy constraints, transmit instructions to code execution engine 102 to not execute the analyzed code.

In some embodiments, decision and reporting module 116 may transmit information regarding the code execution determination, optionally along with explainability information, to code execution engine 102, for example for transmission to a user or system such as user system 104 attempting to execute the analyzed code.

In some embodiments, decision and reporting module 116 may transmit information regarding any code (including the code itself) that is determined to be malicious (e.g., that is determined to violate one or more privacy constraints) to one or more systems and/or administrators of system 100. For example, malicious code may be reported to and transmitted to a data owner system against which the code sought to execute, and/or may be transmitted to another system administrator system.

In some embodiments, decision and reporting module 116 may transmit a request for additional information to one or more of data owner systems 108a-108c, and may receive responsive information that may be used by system 110 to determine whether privacy constraints for the analyzed code are satisfied. In some embodiments, decision and reporting module 116 may transmit a request for an external or human decision regarding code execution from one or more of data owner systems 108a-108c, and may receive responsive input indicating whether the analyzed code should be executed.

In some embodiments, information transmitted to one or more of data owner systems 108a-108c in an “edge case” may include explainability information as described herein, such that the reasoning of the system's analysis is transparently conveyed to the data owner system for further consideration and analysis by the data owner system. In one example, decision and reporting module 116 may transmit the following to a data owner system: “In this code snippet, there is direct data leakage since df (containing raw CSV data from S3) is saved externally to S3.” Sending this information to a data owner system may allow the data owners system to pinpoint the cause of leakage. In one example, decision and reporting module 116 may transmit the following to a data owner system: “This code appears to be obfuscated in an attempt to hide the logic and make it difficult to analyze.” Sending this information to a data owner system may raise a flag by the system administrator and flag the user/process sending such a code snippet. Decision and reporting module 116 may thus enable system 100 to be customized in a way that provides the opportunity for enough intervention from outside code analysis system 110 (e.g., manual intervention) and for auditing capabilities, while nonetheless reducing the burden on data owner systems and on human users for a vast majority of the workflow.

After receiving additional information and/or an external decision from a data owner system responsive to information and/or a request transmitted from system 110, decision and reporting module 116 may then transmit code execution instructions and/or explainability information based on said received additional information and/or said received external decision to code execution engine 102.

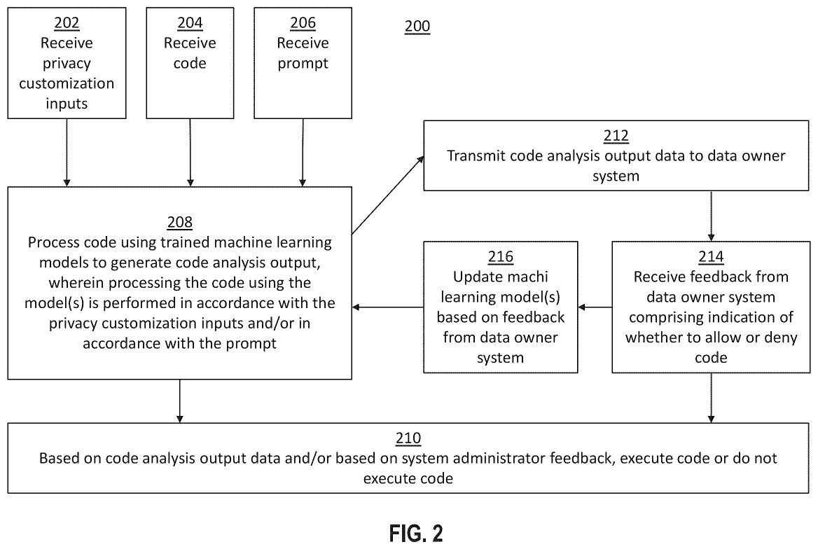

FIG. 2 illustrates a method 200 for code analysis, in accordance with some embodiments. Method 200 may be performed by a system for code analysis comprising one or more processors, such as system 100 described above. In the description of method 200 below, illustrative reference to system 100 is made.

At block 202, in some embodiments, a system may receive privacy customization inputs. For example, code analysis system 110 may receive, from one or more of data owner systems 108a-108c, privacy customization inputs such as those described above with reference to FIG. 1.

At block 204, in some embodiments, the system may receive one or more inputs comprising a prompt. For example, code analysis system 110 may receive, from code execution engine 102, data comprising code to be executed, optionally along with any suitable metadata associated with said code.

At block 206, in some embodiments, the system may receive one or more inputs comprising a prompt. For example, code analysis system 110 may receive, from one or more of data owner systems 108a-108c, a prompt such as those described above with reference to FIG. 1.

At block 208, in some embodiments, the system may process the received code using one or more trained machine learning models to generate code analysis output, wherein processing the code using the model(s) is performed in accordance with the privacy customization inputs and/or in accordance with the prompt. For example, code analysis system 110 may process the received code subject to the privacy customization inputs and the prompt, using code analysis module 114 leveraging machine learning model(s) 120, to generate code analysis output data.

At block 210, in some embodiments, the system may, based on the code analysis output data, execute the code or not execute the code. In some embodiments, the system may generate, store, display, and/or transmit an instruction as to whether or not to execute the code in accordance with the code analysis output data, based on whether the code analysis output data indicates that the code complies or does not comply with one or more privacy constraints. In some embodiments, the instruction may be transmitted to another system for optional action; for example, code analysis system 110 may transmit the instruction to code execution engine 102 for optional action subject to input from user device 104. In some embodiments, the instruction may be automatically acted upon, such that the code is automatically executed or automatically blocked from execution in accordance with the outcome of the code analysis; for example, code execution engine 102 may automatically act upon instructions received from code analysis system 110.

At block 212, in some embodiments, the system may transmit the code analysis output data to a data owner system. For example, code analysis system 110 may transmit code analysis output data, including for example explainability data, to a data owner system 108a-108c. As explained above, the information transmitted to the data owner system may include an indication as to whether the analyzed code complies with privacy constraints, an explanation of the indication and reasoning regarding the analysis of the code, a request for further information to be used to further analyze the code, and/or a request for an indication from the data owner system (e.g., from a human data owner administrator) as to whether the code should be executed.

At block 214, in some embodiments, the system (e.g., code analysis system 100) may receive feedback from the data owner system (e.g., one of systems 108a-108c) comprising an indication of whether to allow or deny execution of the analyzed code. In some embodiments, the feedback many additionally or alternatively comprise further information usable by the code analysis system to further automatically analyze the code, in which case further analysis may be performed and an instruction may according by generated and leveraged for automatic execution or blocking of the code at block 210. In some embodiments in which the feedback received from the data owner system comprises an indication of whether to allow or deny the code, the system may automatically allow or deny execution of the code at block 210 (or may automatically send an instruction, subject to further approval, to allow or deny execution of the code at block 210).

At block 216, in some embodiments, the system may update one or more of the trained machine learning models based on the feedback received from the data owner system, The system may thus perform reinforcement learning to iteratively improve performance of the one or more models used to determine whether privacy constraints are satisfied, wherein the reinforcement learning may be based on the outside feedback received from programmatic determinations and/or human determinations made by the data owner system(s) at block 214. In some embodiments, the feedback loop between data owner system and the code analysis system may be used to generate quality labelled data that can further be used to fine-tune the model(s). In some embodiments, a foundational model may thus be fine-tuned for a specific task by improving the system iteratively, thus allowing fine-tuning for specific kinds of privacy constraints, specific kinds of data sets, and/or specific kinds of code.

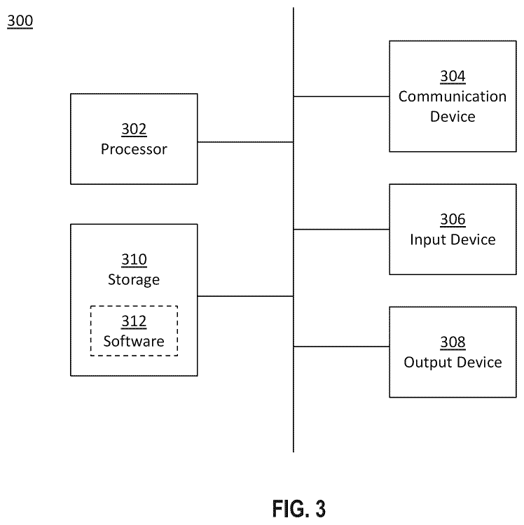

The operations described above, including those described with references to FIGS. 1-2, are optionally implemented by one or more computing systems having components depicted in FIG. 3. It would be clear to a person having ordinary skill in the art how other processes, for example, combinations or sub-combinations of all or part of the operations described above, may be implemented based on the components depicted in FIG. 3. It would also be clear to a person having ordinary skill in the art how the methods, techniques, and systems described herein may be combined with one another, in whole or in part, whether or not those methods, techniques, systems, and/or devices are implemented by and/or provided by the components depicted in FIG. 3.

FIG. 3 depicts a computing device in accordance with some embodiments. Device 300 can be a host computer connected to a network. Device 300 can be a client computer or a server. As shown in FIG. 3, device 300 can be any suitable type of microprocessor-based device, such as a personal computer, workstation, server or handheld computing device (portable electronic device) such as a phone or tablet. The device can include, for example, one or more of processor 302, input device 306, output device 308, storage 310, and communication device 304. Input device 306 and output device 308 can generally correspond to those described above, and can either be connectable or integrated with the computer. In some embodiments, device 300 can forma all or part of system 100, code execution engine 102, one or more of data owner systems 108a-108c, and/or code analysis system 110.

Input device 306 can be any suitable device that provides input, such as a touch screen, keyboard or keypad, mouse, or voice-recognition device. Output device 308 can be any suitable device that provides output, such as a touch screen, haptics device, or speaker.

Storage 310 can be any suitable device that provides storage, such as an electrical, magnetic or optical memory including a RAM, cache, hard drive, or removable storage disk. Communication device 304 can include any suitable device capable of transmitting and receiving signals over a network, such as a network interface chip or device. The components of the computer can be connected in any suitable manner, such as via a physical bus or wirelessly.

Software 312, which can be stored in storage 310 and executed by processor 302, can include, for example, the programming that embodies the functionality of the present disclosure (e.g., as embodied in the devices as described above).

Software 312 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 310, that can contain or store programming for use by or in connection with an instruction execution system, apparatus, or device.

Software 312 can also be propagated within any transport medium for use by or in connection with an instruction execution system, apparatus, or device, such as those described above, that can fetch instructions associated with the software from the instruction execution system, apparatus, or device, and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 300 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 300 can implement any operating system suitable for operating on the network. Software 312 can be written in any suitable programming language, such as C, C++, Java, or Python. In various embodiments, application software embodying the functionality of the present disclosure can be deployed in different configurations, such as in client/server arrangement or through a Web browser as a Web-based application or Web service, for example.

### Example 1

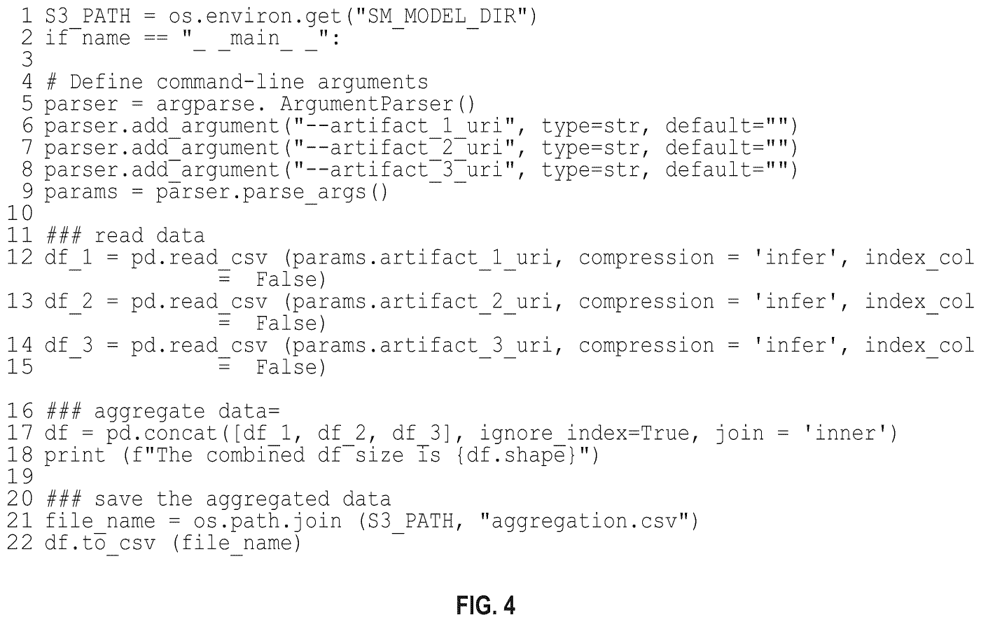

In a first example, the code shown in FIG. 4 was provided as code input for execution subject to confirmation of compliance with privacy constraints, as confirmed by a code analysis system such as the systems described herein.

The following privacy customization input was provided to an LLM of the code analysis system: “Consider any data from S3 as sensitive.”

The following prompt input was provided to the LLM of the code analysis system: “Respond if the code snippet attached leaks raw data when used as an entry point for SageMaker.”

Responsively, the code analysis system processed the code subject to the prompt input and the privacy customization input, to generate the following code analysis output: “Based on the code snippet, there does appear to be potential data leakage.”

The code analysis output generated by the code analysis system also included the following explainability/reasoning output: “The raw CSV data from S3 is directly loaded into dataframes (df_1, df_2, df_3) and then aggregated into a combined df, which is then saved back to S3. Some potential issues: 1. The raw CSV data may contain sensitive information that gets aggregated into the final df. There does not appear to be any sanitization/preprocessing of this data before aggregation. 2. The combined df is then saved to S3, which would leak this aggregated data outside of SageMaker. 3. The S3 bucket name/path is hardcoded in the code. This means anyone with access to the source code would know where the raw data and aggregated data is stored.”

Thus, the first example demonstrates a case in which the system correctly detected leakage and provided information usable by a system administrator (e.g., data owner) to understand the system's determination and relevant reasoning.

### Example 2

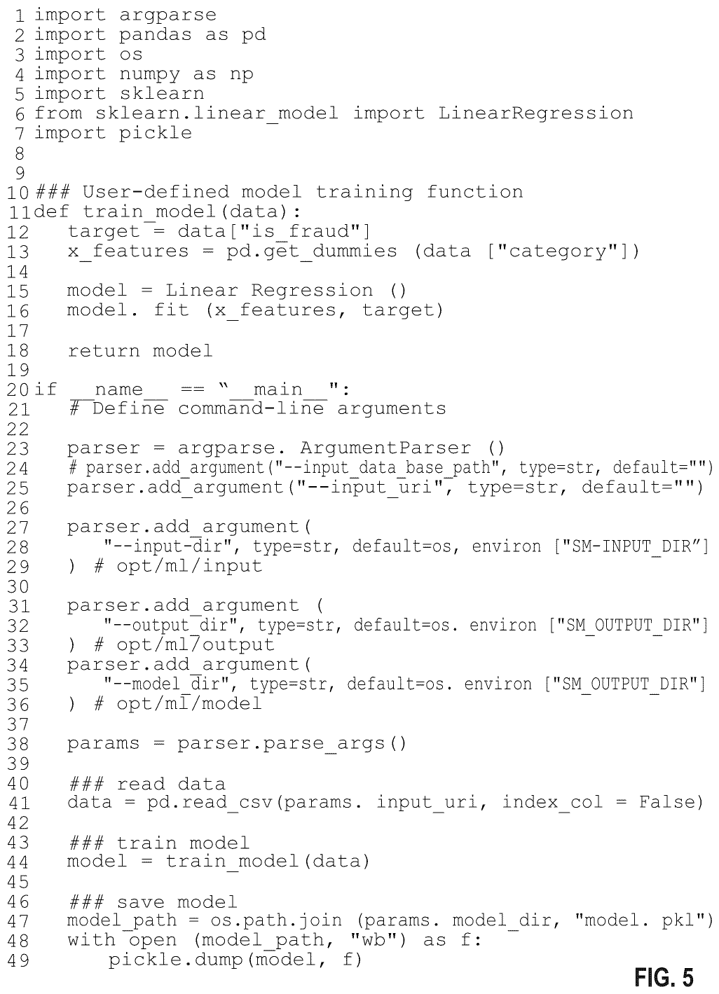

In a second example, the code shown in FIG. 5 was provided as code input for execution subject to confirmation of compliance with privacy constraints, as confirmed by a code analysis system such as the systems described herein.

The following privacy customization input was provided to an LLM of the code analysis system: “Standard assumptions of a federated learning scenario.”

The following prompt input was provided to the LLM of the code analysis system: “Respond if the code snippet attached leaks raw data when used as an entry point for SageMaker.”

Responsively, the code analysis system processed the code subject to the prompt input and the privacy customization input, to generate the following code analysis output: “Based on the code snippet, there does not appear to be data leakage.”

The code analysis output generated by the code analysis system also included the following explainability/reasoning output: “This entry point file: 1. Loads data from S3 (params.input uri) into a dataframe (data). 2. Trains a model on this data. 3. Saves the trained model to model dir (within SageMaker) It does not save any raw data externally, so there is no data leakage. The trained model parameters and gradients are not considered leakage.

Thus, the second example demonstrates a case in which the system understood the nuances between model parameters and gradients versus raw data necessary for federated learning systems. In federated learning systems, it may be acceptable to have a flow of information from satellite systems to a central system when the information is gradients or model updates. However, such a flow may be unacceptable if the information is raw data.

When considering a conventional remote code execution system, it may be difficult for a system to determine from code analysis that there is no raw information flowing to the central location. This example demonstrates that systems such as those disclosed herein may be able to make this distinction, and thus may allow permissible information flow (e.g., in federated learning systems) while blocking other, impermissible information flow (e.g., in federated learning systems).

### Example 3

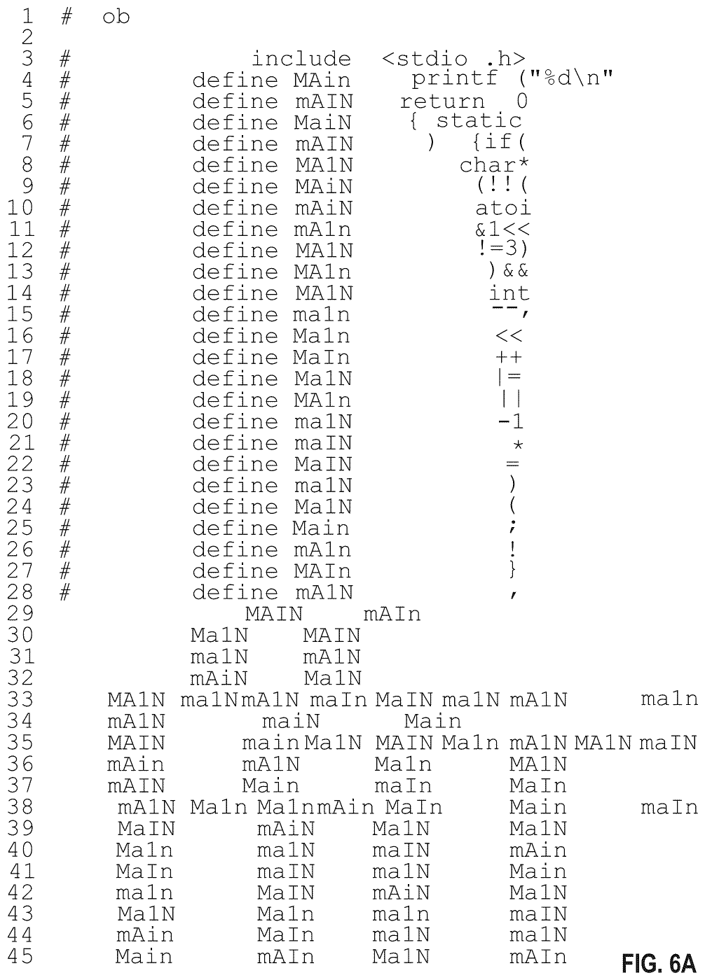

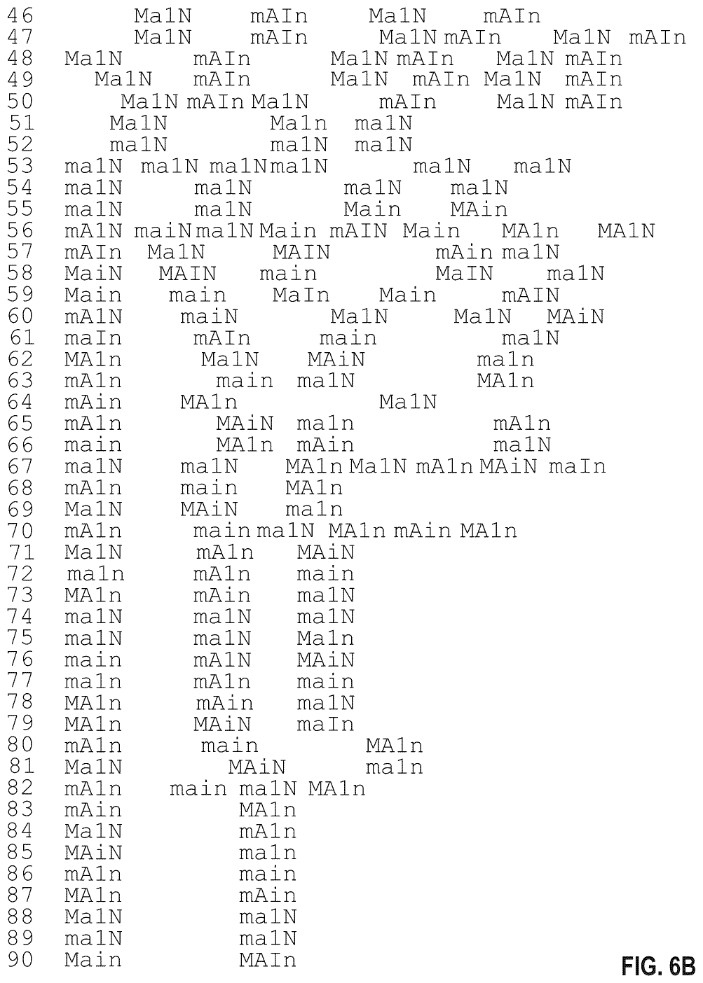

In a third example, the code shown in FIGS. 6A-6B (the initial lines of code are shown in FIG. 6A, and the subsequent lines of code are shown in FIG. 6B) was provided as code input for execution subject to confirmation of compliance with privacy constraints, as confirmed by a code analysis system such as the systems described herein.

The following privacy customization input was provided to an LLM of the code analysis system: “Consider any data from S3 as sensitive and assume a federated learning scenario.”

The following prompt input was provided to the LLM of the code analysis system: “Respond if the code snippet attached leaks raw data when used as an entry point for SageMaker.”

Responsively, the code analysis system processed the code subject to the prompt input and the privacy customization input, to generate the following code analysis output: “This code appears to be obfuscated in an attempt to hide the logic and make it difficult to analyze.”

The code analysis output generated by the code analysis system also included the following explainability/reasoning output: “This code appears to be obfuscated in an attempt to hide the logic and make it difficult to analyze. However, by defining many macros with similar sounding names like MAIN, MaiN, mAiN, etc., it is still possible to deduce some things: 1. It includes stdio.h, so it will print something. 2. There is a main function defined indirectly via the macros. 3. The main function takes the input value, does some bitwise and math operations on it, and prints the result. 4. So while obfuscated, the core logic is to transform the input in some way and print it. The specific transformations are hard to follow due to the macro definitions, but the high level purpose can still be determined. 5. The obfuscation does make it harder to analyze the exact logic and determine if any vulnerabilities are present. But it does not fully hide the intent or prevent making some deductions about the overall functionality. In summary, while obfuscated, some analysis is still possible by looking at the macro definitions and deducing the control flow and high level purpose. But the low level details remain difficult to follow.”

Thus, the third example demonstrates an example of code obfuscation where the response generated by the system would provide a system administrator with enough value to make a decision on the code snippet.

Below is a listing of exemplary enumerated embodiments, any of which may be combined in whole or in part with one another and/or with any other embodiment or other disclosure herein:
Embodiment 1: A system for code analysis, the system comprising one or more processors configured to:
   receive, from a first data owner system, a first input comprising an indication of one or more privacy constraints, wherein the one or more privacy constraints indicate one or more rules for operating on a sensitive data set in a data store associated with the first data owner system;
   receive, from a system authorized to access the data store, data comprising code configured to operate on the sensitive data set;
   apply a first set of one or more machine-learning-trained models to process the first input comprising the indication of the one or more privacy constraints and the data comprising the code to generate code analysis output data, wherein the code analysis output data comprises an indication of whether the code satisfies the one or more privacy constraints; and
   generate and transmit, based at least in part on the code analysis output data, an instruction for the system authorized to access the data store, the instruction indicating whether to execute the code to operate on the sensitive data.
Embodiment 2. The system of embodiment 1, wherein the one or more processors are configured to:
   before applying the first set of one or more models, determining that the system authorized to access the data store satisfies one or more access permission criteria;
   wherein applying the first set of one or more models is performed in accordance with determining that the one or more access criteria are satisfied.
Embodiment 3. The system of any of embodiments 1-2, wherein the one or more processors are configured to:
   before applying the first set of one or more models, determining that a user of the system authorized to access the data store satisfies one or more access permission criteria;
   wherein applying the first set of one or more models is performed in accordance with determining that the one or more access criteria are satisfied.
Embodiment 4. The system of any of embodiments 1-3, wherein the system authorized to access the data store is a server in a federated learning system.
Embodiment 5. The system of any of embodiments 1-4, wherein the data store is a satellite data store in a federated learning system.
Embodiment 6. The system of any of embodiments 1-5, wherein the one or more privacy constraints indicating the one or more rules for operating on the sensitive data set indicate whether a raw data value can be permissibly read by the code and whether data generated based on the raw data value can be permissibly ready by the code.
Embodiment 7. The system of any of embodiments 1-6, wherein the data generated based on the raw data value comprises one or more data types selected from: obfuscated data, redacted data, statistical data, and synthetic data.
Embodiment 8. The system of any of embodiments 1-7, wherein the one or more privacy constraints indicating the one or more rules for operating on the sensitive data set indicate differential privacy rules for data operations on the same data by different parties.
Embodiment 9. The system of any of embodiments 1-8, wherein the system authorized to access the data store is a remote code execution engine.
Embodiment 10. The system of any of embodiments 1-9, wherein the one or more machine-learning-trained models comprise a plurality of models configured in a mixture-of-experts configuration.
Embodiment 11. The system of any of embodiments 1-10, wherein the one or more trained models comprise a large language model (LLM).
Embodiment 12. The system of any of embodiments 1-11, wherein the code analysis output data comprises an explainability indicator providing a human-readable explanation of one or more reasons that the code does or does not satisfy the one or more privacy constraints.
Embodiment 13. The system of any of embodiments 1-12, wherein the one or more processors are configured to:
   based at least in part on the code analysis output data, transmit information to the first data owner system soliciting input from the data owner system regarding whether the code satisfies the one or more privacy constraints; and
   receive, from the data owner system, responsive to the information soliciting input, a second input comprising an indication of whether the code satisfies the one or more privacy constraints;
   wherein generating and transmitting the instruction indicating whether to execute the code to operate on the sensitive data is based at least in part on the second input comprising the indication of whether the code satisfies the one or more privacy constraints.
Embodiment 14. The system of embodiment 13, wherein the one or more processors are configured to update at least one of the first set of one or more machine-learning-trained models by further training the at least one model based at least in part on the code and based at least in part on the second input comprising the indication of whether the code satisfies the one or more privacy constraints.
Embodiment 15. The system of any of embodiments 1-14, wherein:
   the instruction indicating whether to execute the code indicates to execute the code; and
   the one or more processors are configured to, in accordance with the instruction, cause the system authorized to access the data store to execute the code.
Embodiment 16. A non-transitory computer-readable storage medium storing instructions for code analysis, the instructions configured to be executed by one or more processors of a system to cause the system to:
   receive, from a first data owner system, a first input comprising an indication of one or more privacy constraints, wherein the one or more privacy constraints indicate one or more rules for operating on a sensitive data set in a data store associated with the first data owner system;
   receive, from a system authorized to access the data store, data comprising code configured to operate on the sensitive data set;
   apply a first set of one or more machine-learning-trained models to process the first input comprising the indication of the one or more privacy constraints and the data comprising the code to generate code analysis output data, wherein the code analysis output data comprises an indication of whether the code satisfies the one or more privacy constraints; and
   generate and transmit, based at least in part on the code analysis output data, an instruction for the system authorized to access the data store, the instruction indicating whether to execute the code to operate on the sensitive data.
Embodiment 17. The non-transitory computer-readable storage medium of embodiment 16, wherein the instructions are configured to be executed by one or more processors of a system to cause the system to:
   based at least in part on the code analysis output data, transmit information to the first data owner system soliciting input from the data owner system regarding whether the code satisfies the one or more privacy constraints; and
   receive, from the data owner system, responsive to the information soliciting input, a second input comprising an indication of whether the code satisfies the one or more privacy constraints;
   wherein generating and transmitting the instruction indicating whether to execute the code to operate on the sensitive data is based at least in part on the second input comprising the indication of whether the code satisfies the one or more privacy constraints.
Embodiment 18. The non-transitory computer-readable storage medium of embodiment 17, wherein the instructions are configured to be executed by one or more processors of a system to cause the system to update at least one of the first set of one or more machine-learning-trained models by further training the at least one model based at least in part on the code and based at least in part on the second input comprising the indication of whether the code satisfies the one or more privacy constraints.
Embodiment 19. A method for code analysis, the method configured to be performed by a system comprising one or more processors, the method comprising:
   receiving, from a first data owner system, a first input comprising an indication of one or more privacy constraints, wherein the one or more privacy constraints indicate one or more rules for operating on a sensitive data set in a data store associated with the first data owner system;
   receiving, from a system authorized to access the data store, data comprising code configured to operate on the sensitive data set;
   applying a first set of one or more machine-learning-trained models to process the first input comprising the indication of the one or more privacy constraints and the data comprising the code to generate code analysis output data, wherein the code analysis output data comprises an indication of whether the code satisfies the one or more privacy constraints; and
   generating and transmitting, based at least in part on the code analysis output data, an instruction for the system authorized to access the data store, the instruction indicating whether to execute the code to operate on the sensitive data.
Embodiment 20. The method of embodiment 19, comprising:
   based at least in part on the code analysis output data, transmitting information to the first data owner system soliciting input from the data owner system regarding whether the code satisfies the one or more privacy constraints; and
   receiving, from the data owner system, responsive to the information soliciting input, a second input comprising an indication of whether the code satisfies the one or more privacy constraints;
   wherein generating and transmitting the instruction indicating whether to execute the code to operate on the sensitive data is based at least in part on the second input comprising the indication of whether the code satisfies the one or more privacy constraints.
Embodiment 21. The method of embodiment 20, comprising updating at least one of the first set of one or more machine-learning-trained models by further training the at least one model based at least in part on the code and based at least in part on the second input comprising the indication of whether the code satisfies the one or more privacy constraints.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A system for code analysis, the system comprising one or more processors configured to:
receive, from a first data owner system, a first input comprising an indication of one or more privacy constraints, wherein the one or more privacy constraints indicate one or more rules for operating on a sensitive data set in a data store associated with the first data owner system;
receive, from a system authorized to access the data store, data comprising code configured to operate on the sensitive data set;
apply a first set of one or more machine-learning-trained models to process the first input comprising the indication of the one or more privacy constraints and the data comprising the code to generate code analysis output data, wherein the code analysis output data comprises an indication of whether the code satisfies the one or more privacy constraints; and
generate and transmit, based at least in part on the code analysis output data, an instruction for the system authorized to access the data store, the instruction indicating whether to execute the code to operate on the sensitive data.

2. The system of claim 1, wherein the one or more processors are configured to:
before applying the first set of one or more models, determining that the system authorized to access the data store satisfies one or more access permission criteria;
wherein applying the first set of one or more models is performed in accordance with determining that the one or more access criteria are satisfied.

3. The system of claim 1, wherein the one or more processors are configured to:
before applying the first set of one or more models, determining that a user of the system authorized to access the data store satisfies one or more access permission criteria;
wherein applying the first set of one or more models is performed in accordance with determining that the one or more access criteria are satisfied.

4. The system of claim 1, wherein the system authorized to access the data store is a server in a federated learning system.

5. The system of claim 1, wherein the data store is a satellite data store in a federated learning system.

6. The system of claim 1, wherein the one or more privacy constraints indicating the one or more rules for operating on the sensitive data set indicate whether a raw data value can be permissibly read by the code and whether data generated based on the raw data value can be permissibly ready by the code.

7. The system of claim 1, wherein the data generated based on the raw data value comprises one or more data types selected from: obfuscated data, redacted data, statistical data, and synthetic data.

8. The system of claim 1, wherein the one or more privacy constraints indicating the one or more rules for operating on the sensitive data set indicate differential privacy rules for data operations on the same data by different parties.

9. The system of claim 1, wherein the system authorized to access the data store is a remote code execution engine.

10. The system of claim 1, wherein the one or more machine-learning-trained models comprise a plurality of models configured in a mixture-of-experts configuration.

11. The system of claim 1, wherein the one or more trained models comprise a large language model (LLM).

12. The system of claim 1, wherein the code analysis output data comprises an explainability indicator providing a human-readable explanation of one or more reasons that the code does or does not satisfy the one or more privacy constraints.

13. The system of claim 1, wherein the one or more processors are configured to:
based at least in part on the code analysis output data, transmit information to the first data owner system soliciting input from the data owner system regarding whether the code satisfies the one or more privacy constraints; and
receive, from the data owner system, responsive to the information soliciting input, a second input comprising an indication of whether the code satisfies the one or more privacy constraints;
wherein generating and transmitting the instruction indicating whether to execute the code to operate on the sensitive data is based at least in part on the second input comprising the indication of whether the code satisfies the one or more privacy constraints.

14. The system of claim 13, wherein the one or more processors are configured to update at least one of the first set of one or more machine-learning-trained models by further training the at least one model based at least in part on the code and based at least in part on the second input comprising the indication of whether the code satisfies the one or more privacy constraints.

15. The system of claim 1, wherein:
the instruction indicating whether to execute the code indicates to execute the code; and
the one or more processors are configured to, in accordance with the instruction, cause the system authorized to access the data store to execute the code.

16. A non-transitory computer-readable storage medium storing instructions for code analysis, the instructions configured to be executed by one or more processors of a system to cause the system to:
receive, from a first data owner system, a first input comprising an indication of one or more privacy constraints, wherein the one or more privacy constraints indicate one or more rules for operating on a sensitive data set in a data store associated with the first data owner system;
receive, from a system authorized to access the data store, data comprising code configured to operate on the sensitive data set;
apply a first set of one or more machine-learning-trained models to process the first input comprising the indication of the one or more privacy constraints and the data comprising the code to generate code analysis output data, wherein the code analysis output data comprises an indication of whether the code satisfies the one or more privacy constraints; and
generate and transmit, based at least in part on the code analysis output data, an instruction for the system authorized to access the data store, the instruction indicating whether to execute the code to operate on the sensitive data.

17. The non-transitory computer-readable storage medium of claim 16, wherein the instructions are configured to be executed by one or more processors of a system to cause the system to:
based at least in part on the code analysis output data, transmit information to the first data owner system soliciting input from the data owner system regarding whether the code satisfies the one or more privacy constraints; and
receive, from the data owner system, responsive to the information soliciting input, a second input comprising an indication of whether the code satisfies the one or more privacy constraints;
wherein generating and transmitting the instruction indicating whether to execute the code to operate on the sensitive data is based at least in part on the second input comprising the indication of whether the code satisfies the one or more privacy constraints.

18. The non-transitory computer-readable storage medium of claim 17, wherein the instructions are configured to be executed by one or more processors of a system to cause the system to update at least one of the first set of one or more machine-learning-trained models by further training the at least one model based at least in part on the code and based at least in part on the second input comprising the indication of whether the code satisfies the one or more privacy constraints.

19. A method for code analysis, the method configured to be performed by a system comprising one or more processors, the method comprising:
receiving, from a first data owner system, a first input comprising an indication of one or more privacy constraints, wherein the one or more privacy constraints indicate one or more rules for operating on a sensitive data set in a data store associated with the first data owner system;
receiving, from a system authorized to access the data store, data comprising code configured to operate on the sensitive data set;
applying a first set of one or more machine-learning-trained models to process the first input comprising the indication of the one or more privacy constraints and the data comprising the code to generate code analysis output data, wherein the code analysis output data comprises an indication of whether the code satisfies the one or more privacy constraints; and
generating and transmitting, based at least in part on the code analysis output data, an instruction for the system authorized to access the data store, the instruction indicating whether to execute the code to operate on the sensitive data.

20. The method of claim 19, comprising:
based at least in part on the code analysis output data, transmitting information to the first data owner system soliciting input from the data owner system regarding whether the code satisfies the one or more privacy constraints; and
receiving, from the data owner system, responsive to the information soliciting input, a second input comprising an indication of whether the code satisfies the one or more privacy constraints;
wherein generating and transmitting the instruction indicating whether to execute the code to operate on the sensitive data is based at least in part on the second input comprising the indication of whether the code satisfies the one or more privacy constraints.

21. The method of claim 20, comprising updating at least one of the first set of one or more machine-learning-trained models by further training the at least one model based at least in part on the code and based at least in part on the second input comprising the indication of whether the code satisfies the one or more privacy constraints.
